(19) United States
(12) Patent Application Publication
(10) Pub. No.: US 2026/0330673 A1
(43) Pub. Date: Oct. 22, 2026

(54) VISION-BASED LOCALIZATION METHODS AND APPARATUSES THEREOF

(71) Applicant: NAVER CORPORATION, Seongnam-si (KR)

(72) Inventors: Taejae LEE, Seongnam-si (KR); Dongki JUNG, Seongnam-si (KR); Suyong YEON, Seongnam-si (KR); Donghwan LEE, Seongnam-si (KR)

(73) Assignee: NAVER CORPORATION, Seongnam-si (KR)

(21) Appl. No.: 19/692,646

(22) Filed: May 29, 2026

Related U.S. Application Data
(63) Continuation of application No. PCT/KR2024/095493, filed on Mar. 14, 2024.

(30) Foreign Application Priority Data
Nov. 29, 2023 (KR) 10-2023-0169736

(51) Int. Cl. G06T 7/70; G06F 3/0482; G06F 3/0488; G06V 10/44

(52) U.S. Cl. CPC G06T 7/70; G06F 3/0482; G06F 3/0488; G06V 10/443

(57) ABSTRACT

The present disclosure relates to a vision-based localization method performed by an operation server or a worker terminal, including the steps of: transmitting map information about a target space to a worker terminal; receiving, from the worker terminal, image information related to an image captured at a specific location in the target space and additional information related to the specific location; and recognizing the location of the image based on the image information and the additional information.

This application is a continuation of, and claims the benefit of priority under 35 U.S.C. § 365(c) from International Application No. PCT/KR2024/095493, filed on Mar. 14, 2024 in the World Intellectual Property Organization (WIPO), which designates the United States of America and claims priority benefit of Korean Patent Application No. 10-2023-0169736, filed on Nov. 29, 2023, the disclosures of each of which are incorporated herein by reference.

### TECHNICAL FIELD

The present disclosure relates to vision-based localization technology and, more specifically, to a method and an apparatus for real-time localization of an image captured by a camera in a target space.

### BACKGROUND

Vision-based localization technology refers to a technology for finding the location and angle of a camera used to capture images by using images input from the camera. Such vision-based localization technology is essential for spatial mapping, spatial reconstruction, autonomous robots, or augmented reality navigation.

Vision-based localization technology generally uses a Structure-From-Motion (SFM) scheme or a Simultaneous Localization And Mapping (SLAM) scheme. According to these schemes, previously captured and processed images are searched for images similar to a currently captured image, where the location and angle of the previously captured and processed images are known. By local feature matching the currently captured image to similar previously captured images, the location of the currently captured image is estimated.

However, if the target space is repetitive or has insufficient features, the performance of localization according to conventional schemes within the target space is deteriorated. Therefore, there is a need for a scheme for improving the performance of localization in a space which is repetitive or has insufficient features.

### SUMMARY

Some example embodiments include a method for real-time localization of an image currently captured by a camera in a target space, based on adjacent node information input from a worker, and an apparatus therefor.

Some example embodiments include a method for real-time localization of an image currently captured by a camera in a target space, based on camera location information input from a worker, and an apparatus therefor.

Some example embodiments of the present disclosure include a vision-based localization method performed by a computation server, the vision-based localization method including: transmitting a map information regarding a target space to a worker terminal; receiving, from the worker terminal, image information related to an image captured at a specific location in the target space and additional information related to the specific location; and determining the specific location of the image based on the image information and the additional information.

Some example embodiments of the disclosure include an apparatus configured to perform vision-based localization, the apparatus including at least one memory configured to store instructions; and at least one processor configured to execute the instructions and cause the apparatus to perform: transmit map information regarding a target space to a worker terminal; receive image information captured at a specific location in the target space and additional information of a worker related to the specific location from the worker terminal; and localize an image captured at the specific location, based on the image information and additional information received from the worker terminal.

Another aspect of the disclosure provides a vision-based localization method performed by a worker terminal, the vision-based localization method including: displaying map information regarding a target space on a display unit; acquiring image information captured at a specific location in the target space; receiving, from a worker, additional information related to the specific location; and determining the specific location based on the image information and the additional information.

Another aspect of the disclosure provides an apparatus configured to perform vision-based localization, the apparatus including at least one memory configured to store instructions; and at least one processor configured to execute the instructions and cause the apparatus to perform: display map information regarding a target space on a display unit; acquire image information captured at a specific location in the target space; receive, from a worker, additional information related to the specific location; and determine the specific location based on the image information and the additional information.

Furthermore, solutions to problems described above are not intended to list all the features of the disclosure. Various features of the present disclosure and advantageous effects based thereon will be more fully understood with reference to some of the following example embodiments.

Advantageous effects of the method and apparatus for vision-based localization according to some embodiments of the disclosure will be described below.

At least one of the embodiments of the disclosure is advantageous in that real-time localization is performed based on current image information captured through the camera and additional information input from the worker such that the possibility of mismatching with other node images in the target space is reduced, thereby improving the success rate and accuracy of localization of the currently captured image.

In addition, at least one of the embodiments of the disclosure is advantageous in that real-time localization is performed based on current image information captured through the camera and adjacent node information input from the worker such that the possibility of mismatching with other node images in the target space is reduced, thereby improving the success rate and accuracy of localization of the currently captured image.

In addition, at least one of the embodiments of the disclosure is advantageous in that real-time localization is performed based on current image information captured through the camera and camera location information input from the worker such that the possibility of mismatching with other node images in the target space is reduced, thereby improving the success rate and accuracy of localization of the currently captured image.

However, advantageous effects that may be accomplished by the method and apparatus for vision-based localization according to some embodiments of the disclosure are not limited to the advantageous effects mentioned above, and other advantageous effects not mentioned herein will be clearly understood by those skilled in the art to which the disclosure pertains from the following description.

### BRIEF DESCRIPTION OF DRAWINGS

Embodiments of the present disclosure will be described with reference to the accompanying drawings, and like reference numerals denote like elements, but are not limited thereto.

FIG. 1 is a drawing illustrating the configuration of a vision-based localization system according to some embodiments of the disclosure.

FIG. 2 is a drawing showing the configuration of a vision-based localization system according to some embodiments of the disclosure.

FIG. 3 is a drawing illustrating a target space and map information of the target space.

FIG. 4 is a flowchart illustrating a vision-based localization method according to some embodiments of the disclosure.

FIG. 5 and FIG. 6 are drawings referenced to describe the localization method of FIG. 4.

FIG. 7 is a flowchart illustrating a vision-based localization method according to some embodiments of the disclosure.

FIG. 8 and FIG. 9 are diagrams referenced to describe the localization method of FIG. 7.

FIG. 10 is a diagram illustrating the configuration of a vision-based localization system according to some embodiments of the disclosure.

FIG. 11 is a flowchart illustrating a vision-based localization method according to some embodiments of the disclosure.

FIG. 12 is a flowchart illustrating a vision-based localization method according to some embodiments of the disclosure.

FIG. 13 is a block diagram illustrating the configuration of a computing device according to some embodiments of the disclosure.

### DETAILED DESCRIPTION

Hereinafter, some embodiments disclosed in this specification will be described in detail with reference to the accompanying drawings, in which like or similar elements are assigned the same (or similar) reference numerals regardless of the drawing symbols and redundant descriptions thereof will be omitted. The terms “module” and “unit” used for components in the following description are assigned or interchanged only by considering the ease of drafting the specification, and do not have distinct meanings or roles in themselves. That is, the term “unit” used in the disclosure refers to a software or hardware component, such as an FPGA or ASIC, and the “unit” performs a certain function. However, the term “unit” is not intended to be limited to software or hardware. The “unit” may be configured to reside in an addressable storage medium, or may be configured to execute on one or more processors. Therefore, as an example, the “unit” includes components such as software components, object-oriented software components, class components, and task components, processes, functions, properties, procedures, subroutines, segments of program code, drivers, firmware, microcode, circuits, data, databases, data structures, tables, arrays, and variables. The functions provided in the components and “units” may be combined into a smaller number of components and “units” or may be further divided into additional components and “units.”

In addition, when a detailed description of a related known technology is determined to obscure the subject matter of some embodiments disclosed in this specification, the detailed description will be omitted in the description of some of the embodiments disclosed in this specification. In addition, the attached drawings are for the purpose of easily understanding some of the embodiments disclosed in this specification, and the technical ideas disclosed in this specification are not limited by the attached drawings. It should be understood that all modifications, equivalents, and substitutes included in the idea and scope of the disclosure are also included therein.

The disclosure proposes a method for real-time localization of an image currently captured by a camera in a target space, based on additional information input from a worker, and an apparatus therefor. In addition, the disclosure proposes a method for real-time localization of an image currently captured by a camera in a target space, based on adjacent node information input from a worker, and an apparatus therefor. In addition, the disclosure proposes a method for real-time localization of an image currently captured by a camera in a target space, based on camera location information input from a worker, and an apparatus therefor.

The target space described in this specification includes all spaces that are the subject of localization and mapping. Hereinafter, in some embodiments, the description will be made with the indoor space as an example target space for the convenience of the description, but this is not necessarily limitative, and it will be apparent to those skilled in the art that the outdoor space may be the target.

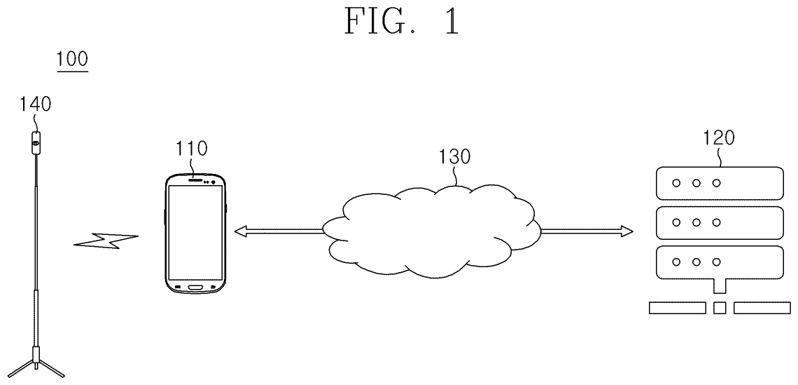

FIG. 1 is a diagram illustrating the configuration of a vision-based localization system according to some embodiments of the disclosure.

Referring to FIG. 1, the vision-based localization system 100 according to some embodiments of the disclosure may include a worker terminal (or scan terminal, 110), a computation server (or processing server, 120), a communication network 130, and a camera 140.

The worker terminal 110 and the computation server 120 may be connected through the communication network 130.

The communication network 130 may include a wired network and a wireless network, and may specifically include various networks such as a local area network (LAN), a metropolitan area network (MAN), and a wide area network (WAN). In addition, the communication network 130 may include the well-known World Wide Web (WWW). However, the communication network 130 according to the disclosure is not limited to the networks listed above, and may include at least one of a known wireless data network, a known telephone network, and a known wired/wireless television network.

The worker terminal 110 may request a separate camera 140 to capture an image of the target space. The camera 140 may capture an image of the target space in response to the capture request signal from the worker terminal 110 and then transmit the captured image to the worker terminal 110. The worker terminal 110 and the camera 140 may transmit/receive data through short-range wireless communication. The short-range wireless communication may use at least one of Bluetooth™, radio frequency identification (RFID), infrared communication (IrDA), ultrawideband (UWB), ZigBee, near field communication (NFC), wireless-fidelity (Wi-Fi), Wi-Fi direct, and wireless universal serial bus (wireless USB).

The worker terminal 110 may transmit an image acquired from the camera 140 to the computation server 120. The computation server 120 may generate a map of the target space in real time, based on the image received from the worker terminal 110.

The worker terminal 110 may receive map information constructed regarding the target space from the computation server 120. The worker terminal 110 may display the received map information on the display unit. The worker may thereby identify, in real time, the result of localizing images captured through the camera and the result of map construction.

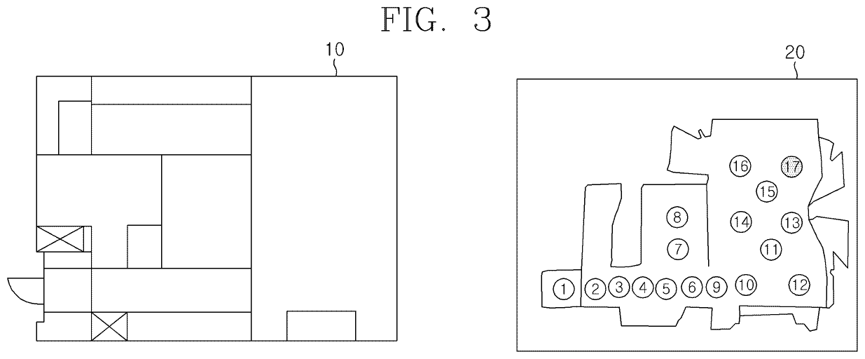

For example, as shown in FIG. 3, if the target space 10 is an apartment indoor space, the worker terminal 110 may transmit an image captured at the location of node 17 to the computation server 120. The computation server 120 may generate a map of the target space 10 in real time, based on the image received from the worker terminal 110. The computation server 120 may transmit map information 20 constructed regarding the target space 10 to the worker terminal 110. The worker terminal 110 may display the received map information 20 on the display unit. The map information 20 may include multiple pieces of node information. Each piece of node information corresponds to the order and location at which the image was captured.

When capturing an image using the camera 140, the worker may input additional information that facilitates vision-based localization into the worker terminal 110. The worker terminal 110 may provide the computation server 120 with additional information input from the worker. The additional information may include at least one from among information regarding the node most adjacent to the current capture location, among multiple pieces of node information included in the map information, and camera location information on the map information.

The worker terminal 110, as used herein, may include a mobile phone, a smartphone, a laptop computer, a desktop computer, a digital broadcasting terminal, a personal digital assistant (PDA), a portable multimedia player (PMP), a slate PC, a tablet PC, an ultrabook, a wearable device, or the like.

The computation server 120 may localize images, based on images received from the worker terminal 110. The computation server 120 may estimate the location of images by using one of the structure-from-motion (SFM) scheme and the simultaneous localization and mapping (SLAM) scheme.

The computation server 120 may localize images more accurately, based on not only images received from the worker terminal 110, but also additional information. The computation server 120 may detect a node adjacent to the current capture point, based on additional information received from the worker terminal 110, and may perform local feature matching with images of the detected adjacent node, thereby more accurately estimating the location of the images.

The computation server 120 may generate a map of the target space, based on location information of images received from the worker terminal 110. The computation server 120 may provide the worker terminal 110 with map information constructed regarding the target space.

The camera 140 may capture at least one of a 360-degree image, a panoramic image, and a general image regarding the target space. The camera 140 may capture the image in response to a capture request signal of the worker terminal 110.

The camera 140 may transmit captured images to the worker terminal 110. The camera 140 may transmit the images to the worker terminal 110 through short-range wireless communication.

As described above, the vision-based localization system according to some embodiments of the disclosure may perform real-time localization based on current image information captured through the camera and additional information input from the worker such that the possibility of mismatching with other node images in the target space is reduced, thereby improving the success rate and accuracy of localization of the currently captured image.

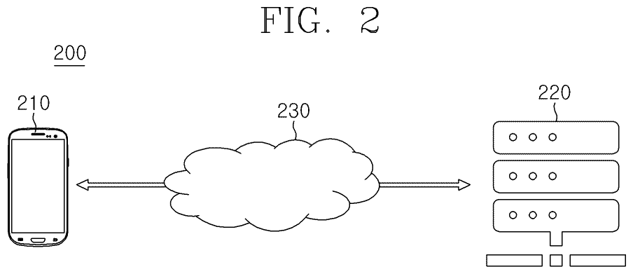

FIG. 2 is a diagram showing the configuration of a vision-based localization system according to some embodiments of the disclosure.

Referring to FIG. 2, the vision-based localization system 200 according to some embodiments of the disclosure may include a worker terminal 210, a computation server 220, and a communication network 230.

The vision-based localization system 200 according to some embodiments may omit a separate camera 140, unlike the localization system 100 according to some of the previous embodiments described above. In some of these embodiments, images of the target space may be captured using a camera installed in the worker terminal 210. That is, the worker terminal 210 may capture an image of the target space using its own camera and provide the captured image to the computation server 220.

Meanwhile, operations and structure of the worker terminal 210, the computation server 220, and the communication network 230, except for the image capture function, are identical or similar to operations of the worker terminal 110, the computation server 120, and the communication network 130 of the localization system 100 according to some of the embodiments described above, and detailed descriptions thereof will be omitted herein.

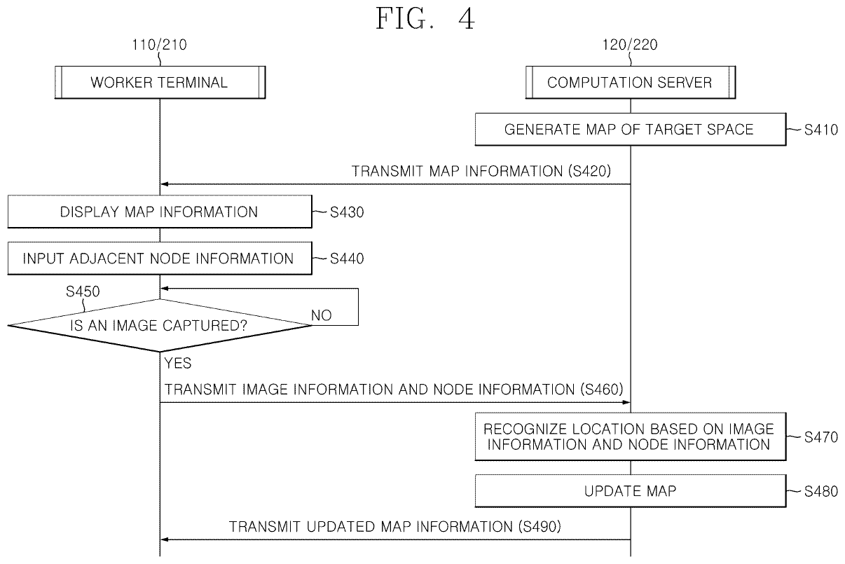

FIG. 4 is a flowchart illustrating a vision-based localization method according to some embodiments of the disclosure. The vision-based localization method according to some of these embodiments may be performed by the localization system 100 or 200 according to some previous embodiments. Although the flowchart illustrates the vision-based localization method as divided into multiple steps, at least some of the steps may be performed in a different order, combined with other steps and performed together, omitted, divided into more detailed steps and performed, or performed with at least one additional step not illustrated.

Referring to FIG. 4, the computation server 120 or 220 may generate, in real time, a map of the target space, based on the images received from the worker terminals 110 or 210 (S410).

The computation server 120 or 220 may transmit map information constructed regarding the target space to the worker terminal 110 or 210 (S420).

The worker terminal 110 or 210 may display the map information received from the computation server 120 or 220 on the display unit (S430).

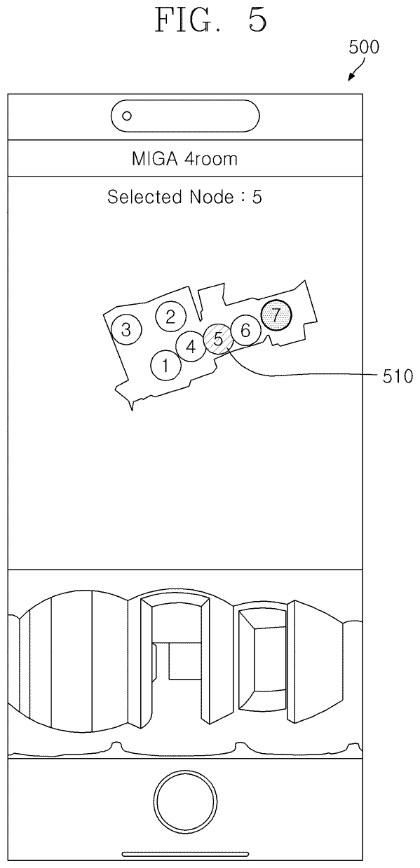

For example, as shown in FIG. 5, the worker terminal 110 or 210 may display map information 500 including 7 pieces of node information on the display unit. Respective pieces of node information correspond to the sequence and location of the images captured through the camera.

The worker may identify, in real time, the result of localizing previous images captured by the camera and the result of map construction, through the map information displayed on the display unit.

Meanwhile, although not shown in the drawing, if the worker confirms with reference to the map information that there is an erroneously localized node, he/she may input a command to the worker terminal 110 or 210 to request deletion of the node. This is intended to reduce the error in localization in advance, which may otherwise accumulate thereafter due to the erroneously localized node information.

The worker terminal 110 or 210 may display a message requesting input of adjacent node information along with map information on the display unit.

When the worker captures an image with the camera at a new location of the target space, he/she may input information about the node that is most adjacent to the current capture point into the worker terminal 110 or 210 (S440). The worker may input adjacent node information by touching the node displayed on the display unit, or may input adjacent node information by using a separate node input menu.

For example, as shown in FIG. 5, if the node most adjacent to the current image capture point is node 5 (510), the worker may input information about node 5 (510) into the worker terminal 110 or 210.

If an image is captured at a new location of the target space (S450), the worker terminal 110 or 210 may transmit the captured image information and adjacent node information to the computation server 120 or 220 (S460).

Meanwhile, it is assumed in the description of some embodiments that the worker terminal 110 or 210 transmits image information and adjacent node information together, but the disclosure is not necessarily limited thereto, and the pieces of information may be transmitted separately.

In addition, it is assumed in the description of some embodiments that adjacent node information is input before capturing an image at a new location of the target space, the disclosure is not necessarily limited thereto and it will be apparent to those skilled in the art that adjacent node information may be input after capturing the image or simultaneously with the capture of the image.

The computation server 120 or 220 may recognize location information of the currently captured image, based on the image information and adjacent node information received from the worker terminal 110 or 210 (S470). The computation server 120 or 220 may detect the image of the adjacent node input by the worker and perform local feature matching with the detected node image, thereby more accurately localizing the currently captured image. The computation server 120 or 220 may thereby reduce the possibility of mismatching with other node images in the target space, thereby improving the success rate and accuracy of the localization.

In some embodiments, the computation server 120 or 220 may identify one or more node images corresponding to adjacent node information input by a worker.

For example, when the worker inputs information indicating that node 5 is adjacent to a current image capture point, the computation server 120 or 220 may identify a node image corresponding to node 5.

The computation server 120 or 220 may perform local feature matching between the currently captured image and the identified node image corresponding to the adjacent node information.

In some embodiments, the computation server 120 or 220 may determine a location of the currently captured image based on the local feature matching result.

Accordingly, the computation server 120 or 220 may reduce mismatching with other node images in the target space and improve localization accuracy for the currently captured image.

The computation server 120 or 220 may update the map of the target space, based on the location information of the currently captured image (S480).

The computation server 120 or 220 may transmit the updated map information to the worker terminal 110 or 210 (S490).

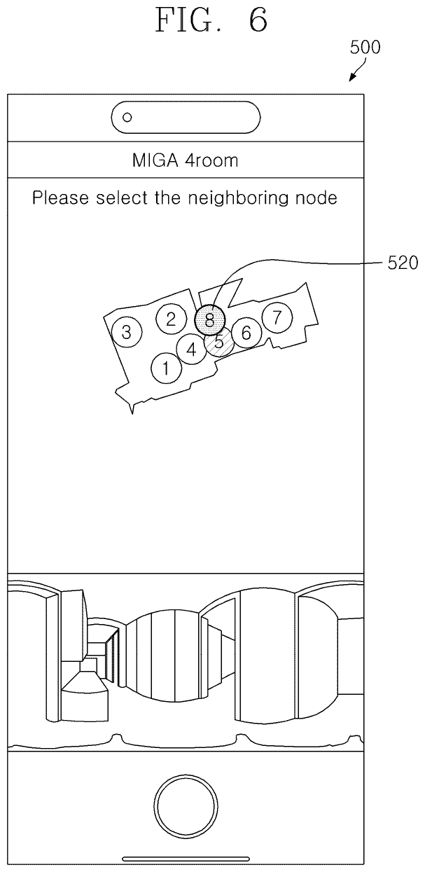

The worker terminal 110 or 210 may display the received map information on the display unit. For example, as shown in FIG. 6, the worker terminal 110 or 210 may display map information 500 including 8 pieces of node information on the display unit. Node 8 (520) corresponds to the location of the currently captured image.

As described above, the vision-based localization method according to some of the previous embodiments of the disclosure may perform real-time localization based on current image information captured through the camera and adjacent node information input from the worker such that the possibility of mismatching with other node images in the target space is reduced, thereby improving the success rate and accuracy of localization of the currently captured image.

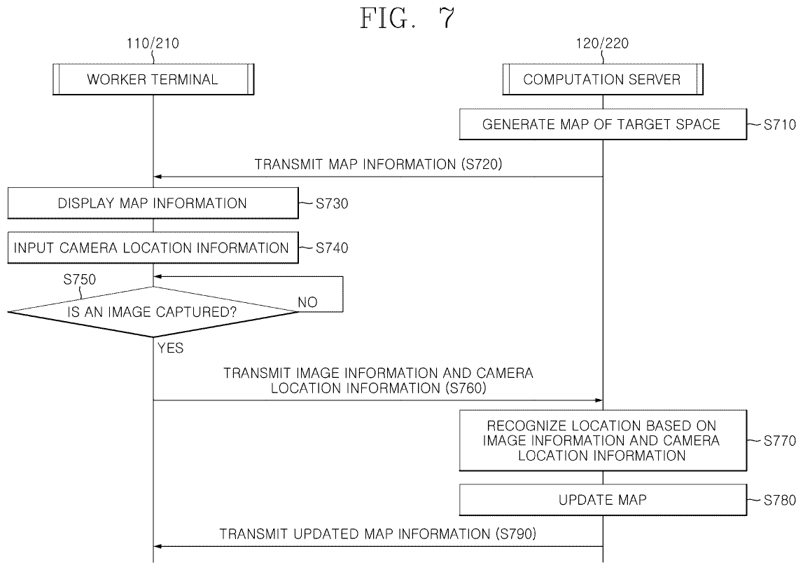

FIG. 7 is a flowchart illustrating a vision-based localization method according to some previous embodiments of the disclosure. The vision-based localization method according to some embodiments may be performed by the localization system 100 or 200 according to some previous embodiments. Although the flowchart illustrates the vision-based localization method as divided into multiple steps, at least some of the steps may be performed in a different order, combined with other steps and performed together, omitted, divided into more detailed steps and performed, or performed with at least one additional step not illustrated.

Referring to FIG. 7, the computation server 120 or 220 may generate, in real time, a map of the target space, based on the images received from the worker terminals 110 or 210 (S710).

The computation server 120 or 220 may transmit map information constructed regarding the target space to the worker terminal 110 or 210 (S720).

The worker terminal 110 or 210 may display the map information received from the computation server 120 or 220 on the display unit (S730).

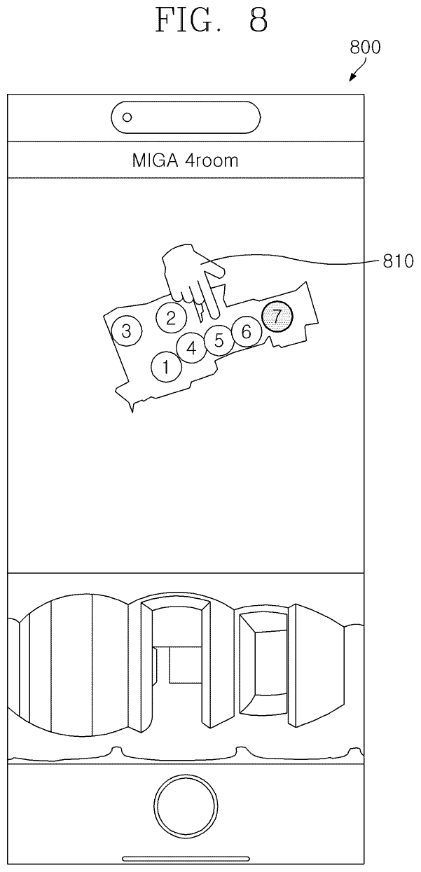

For example, as shown in FIG. 8, the worker terminal 110 or 210 may display map information 800 including 7 pieces of node information on the display unit. Respective pieces of node information correspond to the sequence and location of the images captured through the camera.

The worker may identify, in real time, the result of localizing previous images captured by the camera and the result of map construction, through the map information displayed on the display unit.

The worker terminal 110 or 210 may display a message on the display unit to request the worker to input the current camera's location information, together with map information.

When the worker captures an image with the camera at a new location of the target space, he/she may input the current camera's location information into the worker terminal 110 or 210 (S740). The worker may input camera location information by touching a specific point in the map space displayed on the display unit, or may input camera location information by using a separate node input menu.

For example, as shown in FIG. 8, the worker may input camera location information into the worker terminal 110 or 210 by touching the point at which the camera is currently located in the map space with his/her finger 810.

If an image is captured at a new location of the target space (S750), the worker terminal 110 or 210 may transmit the captured image information and camera location information to the computation server 120 or 220 (S760).

Meanwhile, it is assumed in the description of some embodiments that the worker terminal 110 or 210 transmits image information and camera location information together, but the disclosure is not necessarily limited thereto, and the pieces of information may be transmitted separately.

In addition, it is assumed in the description of some embodiments that camera location information is input before capturing an image at a new location of the target space, the disclosure is not necessarily limited thereto and it will be apparent to those skilled in the art that camera location information may be input after capturing the image or simultaneously with the capture of the image.

The computation server 120 or 220 may recognize location information of the currently captured image, based on the image information and camera location information received from the worker terminal 110 or 210 (S770). The computation server 120 or 220 may detect a node adjacent to the current image capture point, based on camera location information input by the worker, and perform local feature matching with the detected adjacent node image, thereby more accurately localizing the currently captured image. The computation server 120 or 220 may thereby reduce the possibility of mismatching with other node images in the target space, thereby improving the success rate and accuracy of the localization.

In some embodiments, the computation server 120 or 220 may identify one or more adjacent nodes based on camera location information input by a worker.

For example, when the worker inputs approximate camera location information on displayed map information, the computation server 120 or 220 may identify one or more nodes corresponding to the input camera location information.

The computation server 120 or 220 may perform local feature matching between the currently captured image and node images corresponding to the identified adjacent nodes.

In some embodiments, the computation server 120 or 220 may determine a location of the currently captured image based on the local feature matching result.

Accordingly, the computation server 120 or 220 may reduce mismatching with other node images in the target space and improve localization accuracy for the currently captured image.

The computation server 120 or 220 may update the map of the target space, based on the location information of the currently captured image (S780).

The computation server 120 or 220 may transmit the updated map information to the worker terminal 110 or 210 (S790).

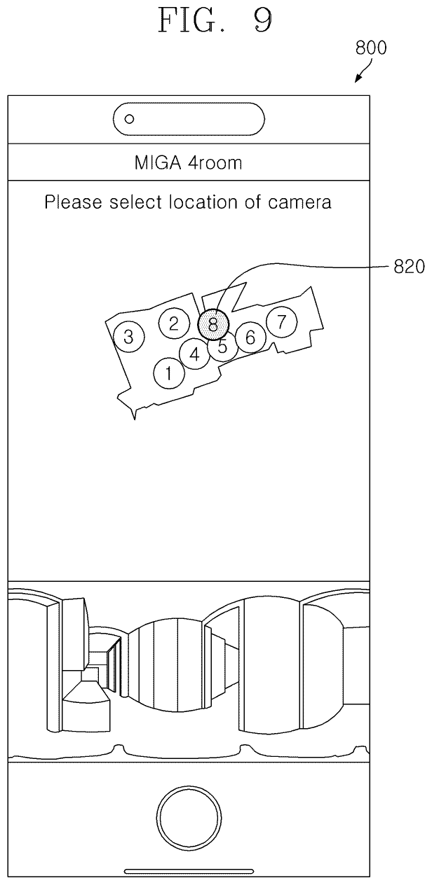

The worker terminal 110 or 210 may display the received map information on the display unit. For example, as shown in FIG. 9, the worker terminal 110 or 210 may display map information 800 including 8 pieces of node information on the display unit. Node 8 (820) corresponds to the location of the currently captured image.

As described above, the vision-based localization system according to some previous embodiments of the disclosure may perform real-time localization based on current image information captured through the camera and camera location information input from the worker such that the possibility of mismatching with other node images in the target space is reduced, thereby improving the success rate and accuracy of localization of the currently captured image.

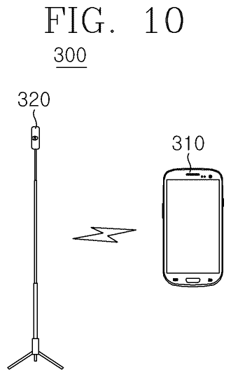

FIG. 10 is a drawing illustrating the configuration of a vision-based localization system according to some embodiments of the disclosure.

Referring to FIG. 10, the vision-based localization system 300 according to some embodiments of the disclosure may include a worker terminal 310 and a camera 320.

The worker terminal 310 may request a separate camera 320 to capture an image of the target space. The camera 320 may capture an image of the target space in response to the image capture request signal of the worker terminal 310, and then transmit the captured image to the worker terminal 310. The worker terminal 310 and the camera 320 may transmit/receive data through short-range wireless communication.

The worker terminal 310 may localize images, based on images received from the camera 320. The worker terminal 310 may estimate the location of images by using one of the structure-from-motion (SFM) scheme and the simultaneous localization and mapping (SLAM) scheme.

The worker terminal 310 may generate a map of the target space in real time, based on location information of the image received from the camera 320.

The worker terminal 310 may display the generated map information on the display unit. The worker may thereby identify the result of localizing images captured through the camera and the result of map construction in real time.

The worker may input additional information, which facilitates vision-based localization, into the worker terminal 310 when capturing images using the camera 320. The additional information may include at least one from among information regarding a node adjacent to the current capture location, among multiple pieces of node information included in the map information, and camera location information on the map information.

The worker terminal 310 may more accurately localize the image, based on not only the image received from the camera 320, but also separate additional information. The worker terminal 310 may detect a node adjacent to the current image capture point, based on the additional information received from the worker, and perform local feature matching with the image of the detected adjacent node, thereby more accurately estimating the location of the image.

The camera 320 may capture at least one of a 360-degree image, a panoramic image, and a general image of the target space. The camera 320 may capture the image in response to the image capture request signal of the worker terminal 110.

The camera 320 may transmit the captured image to the worker terminal 310. The camera 320 may transmit the image to the worker terminal 310 through near-field wireless communication.

As described above, the vision-based localization system according to some embodiments of the disclosure may perform real-time localization, based on current image information captured by the camera and additional information input from the worker such that the possibility of mismatching with other node images in the target space is reduced, thereby improving the success rate and accuracy of localization of the currently captured image.

Meanwhile, although not shown in the drawings, the vision-based localization system according to some embodiments of the disclosure may omit a separate camera 320, unlike the localization system 300 according to some of the previous embodiments described above. In some present embodiments, images of the target space may be captured using a camera installed in the worker terminal 310. That is, the worker terminal 310 may perform a vision-based localization method without interworking with other devices.

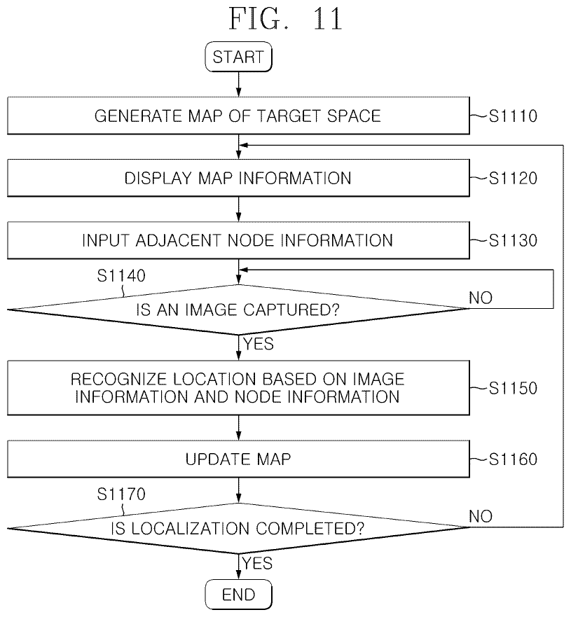

FIG. 11 is a flowchart illustrating a vision-based localization method according to some previous embodiments of the disclosure. The vision-based localization method according to some embodiments may be performed by the localization system 300 according to some previous embodiments. Although the flowchart illustrates the vision-based localization method as divided into multiple steps, at least some of the steps may be performed in a different order, combined with other steps and performed together, omitted, divided into more detailed steps and performed, or performed with at least one additional step not illustrated.

Referring to FIG. 11, the worker terminal 310 may generate, in real time, a map of the target space, based on images received from the camera (S1110).

The worker terminal 310 may display the generated map information on the display unit (S1120). The worker may identify, in real time, the result of localizing previous images captured by the camera and the result of map construction, through the map information displayed on the display unit.

When the worker captures an image with the camera at a new location of the target space, he/she may input node information regarding a node adjacent to the current image capture point into the worker terminal 310 (S1130). The worker may input adjacent node information by touching a node displayed on the display unit, or may input adjacent node information by using a separate node input menu.

If an image is captured at a new location of the target space (S1140), the worker terminal 310 may recognize location information of the currently captured image, based on image information captured by the camera and adjacent node information input from the worker (S1150). The worker terminal 310 may perform local feature matching with the image of the adjacent node input by the worker, thereby localizing the currently captured image more accurately. The worker terminal 310 may thereby reduce the possibility of mismatch with other node images in the target space, thereby improving the success rate and accuracy of the localization.

The worker terminal 310 may update the map of the target space, based on the location information of the currently captured image (S1160). The worker terminal 310 may display the updated map information on a display unit.

The worker terminal 310 may repeatedly perform the operations of steps 1120 to 1160 until the localization process or the map generation process is completed.

As described above, the vision-based localization system according to some previous embodiments of the disclosure may perform real-time localization, based on current image information captured by the camera and adjacent node information input from the worker such that the possibility of mismatching with other node images in the target space is reduced, thereby improving the success rate and accuracy of localization of the currently captured image.

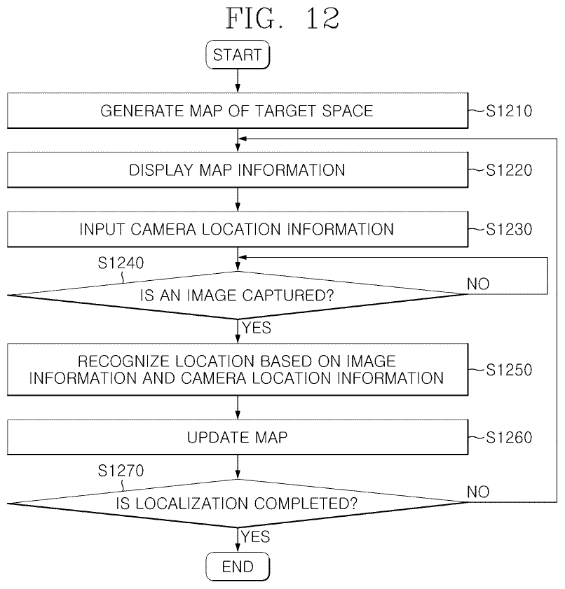

FIG. 12 is a flowchart illustrating a vision-based localization method according to some previous embodiments of the disclosure. The vision-based localization method according to some embodiments may be performed by the localization system 300 according to some previous embodiments. Although the flowchart illustrates the vision-based localization method as divided into multiple steps, at least some of the steps may be performed in a different order, combined with other steps and performed together, omitted, divided into more detailed steps and performed, or performed with at least one additional step not illustrated.

Referring to FIG. 12, the worker terminal 310 may generate, in real time, a map of the target space, based on images received from the camera (S1210).

The worker terminal 310 may display the generated map information on the display unit (S1220). The worker may identify, in real time, the result of localizing previous images captured by the camera and the result of map construction, through the map information displayed on the display unit.

When the worker captures an image with the camera at a new location of the target space, he/she may input the current camera's location information into the worker terminal 310 (S1230). The worker may input camera location information by touching a specific point in the map region displayed on the display unit, or may input camera location information by using a separate node input menu.

If an image is captured at a new location of the target space (S1240), the worker terminal 310 may recognize location information of the currently captured image, based on image information captured by the camera and camera location information input from the worker (S1250). The worker terminal 310 may detect an adjacent node adjacent to the current image capture point, based on camera location information input by the worker, and perform local feature matching with the image of the detected adjacent node input, thereby localizing the currently captured image more accurately. The worker terminal 310 may thereby reduce the possibility of mismatch with other node images in the target space, thereby improving the success rate and accuracy of the localization.

The worker terminal 310 may update the map of the target space, based on the location information of the currently captured image (S1260). The worker terminal 310 may display the updated map information on a display unit.

The worker terminal 310 may repeatedly perform the operations of steps 1220 to 1260 until the localization process or the map generation process is completed.

As described above, the vision-based localization system according to some previous embodiments of the disclosure may perform real-time localization, based on current image information captured by the camera and camera location information input from the worker such that the possibility of mismatching with other node images in the target space is reduced, thereby improving the success rate and accuracy of localization of the currently captured image.

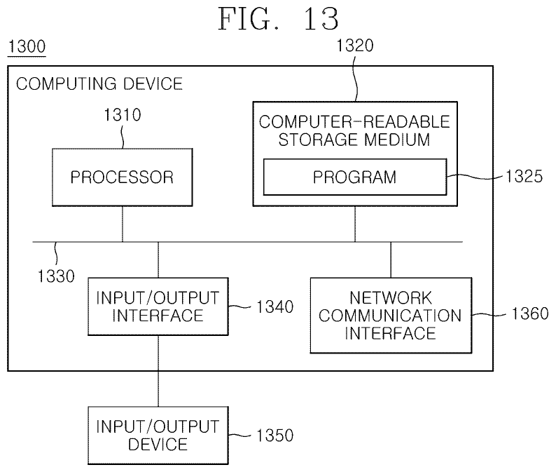

FIG. 13 is a block diagram illustrating the configuration of a computing device according to some embodiments of the disclosure.

Referring to FIG. 13, the computing device 1300 according to some embodiments of the disclosure includes at least one processor 1310, a computer-readable storage medium 1320, and a communication bus 1330. The computing device 1300 may implement the worker terminal 110, 210 or 310 or the computation server 120 or 220 described above.

The processor 1310 may cause the computing device 1300 to operate according to some example embodiments described above. For example, the processor 1310 may execute one or more programs 1325 stored in the computer-readable storage medium 1320. The one or more programs may include one or more computer-executable instructions, and the computer-executable instructions may be configured to cause the computing device 1300 to perform operations according to some example embodiments when executed by the processor 1310.

The non-transitory, computer-readable storage medium 1320 is configured to store computer-executable instructions or program code, program data, and/or other suitable types of information. The program 1325 stored in the computer-readable storage medium 1320 includes a set of instructions executable by the processor 1310. In some example embodiments, the computer-readable storage medium 1320 may be a memory (e.g., a volatile memory such as a random access memory, a non-volatile memory, or a suitable combination thereof), one or more magnetic disk storage devices, optical disk storage devices, flash memory devices, other types of storage media that may be accessed by the computing device 1300 and store desired information, or a suitable combination thereof.

The communication bus 1330 interconnects various different components of the computing device 1300, including the processor 1310 and the computer-readable storage medium 1320.

The computing device 1300 may also include one or more input/output interfaces 1340 that provide interfaces for one or more input/output devices 1350 and one or more network communication interfaces 1360. The input/output interface 1340 and the network communication interface 1360 are connected to the communication bus 1330.

The input/output device 1350 may be connected to other components of the computing device 1300 through the input/output interface 1340. Example input/output devices 1350 may include input devices such as a pointing device (e.g., a mouse or a trackpad), a keyboard, a touch input device (e.g., a touchpad or a touchscreen), a voice or sound input device, various kinds of sensor devices, and/or image capture devices, and/or output devices such as a display device, a printer, a speaker, and/or a network card. An example input/output device 1350 may be included in the computing device 1300 as a component that constitutes the computing device 1300, or may be a separate device distinct from the computing device 1300 and connected to the computing device 1300.

Some embodiments described above may be implemented as a computer-readable code in a non-transitory medium in which a program is recorded. The computer-readable medium may continuously store a computer-executable program or temporarily store the same for execution or download. In addition, the medium may be various type of recording means or storage means combined with a single or multiple pieces of hardware, and is not limited to a medium directly connected to a computer system, but may also be distributed across a network. Examples of the medium may include magnetic media such as a hard disk, a floppy disk, and a magnetic tape, optical recording media such as a CD-ROM and a DVD, magneto-optical media such as a floptical disk, and ROMs, RAMs, and flash memories, which are configured to store program instructions. In addition, other examples of the medium may include recording media or storage media managed by an app store that distributes applications or other sites or servers that supply or distribute various other types of software. Therefore, the above detailed description should not be construed as limiting in all respects and should be considered as illustrative. The scope of the disclosure should be determined by a reasonable interpretation of the appended claims, and all changes within the equivalent scope of the disclosure are included in the scope of the disclosure.

The disclosure is not limited by the above-described embodiments and the accompanying drawings. It will be apparent to those skilled in the art to which the disclosure pertains that components according to the disclosure may be substituted, modified, and changed within a scope not departing from the technical idea of the disclosure.

What is claimed is:

1. A vision-based localization method performed by a computation server, the vision-based localization method comprising:
transmitting map information regarding a target space to a worker terminal;
receiving, from the worker terminal, image information related to an image captured at a specific location in the target space and additional information related to the specific location; and
localizing the image based on the image information and the additional information.

2. The vision-based localization method of claim 1, wherein
the map information includes a plurality of node information relating to a plurality of nodes in the target space, and
the additional information includes at least one adjacent node information of the plurality of node information, the adjacent node information relating to at least one node adjacent to the specific location of the plurality of nodes in the target space.

3. The vision-based localization method of claim 2, wherein the adjacent node information is input to the worker terminal through a touch input on one of a plurality of nodes displayed on the worker terminal.

4. The vision-based localization method of claim 2, wherein the adjacent node information is input to the worker terminal through a node input menu displayed on the worker terminal.

5. The vision-based localization method of claim 2, wherein the localizing includes
detecting at least one adjacent node image captured at least one adjacent node; and
local feature matching the image captured at the specific location with the at least one detected adjacent node image.

6. The vision-based localization method of claim 1, wherein the additional information includes camera location information relating to the specific location of the camera in the map information.

7. The vision-based localization method of claim 6, wherein the camera location information is input to the worker terminal through a touch input regarding a specific point of a map region displayed on the worker terminal.

8. The vision-based localization method of claim 6, wherein the camera location information is input to the worker terminal through a location input menu displayed on the worker terminal.

9. The vision-based localization method of claim 6, wherein the localizing includes
detecting at least one adjacent node image captured at at least one node adjacent to the specific location based on the camera location information, and
local feature matching the image captured at the specific location with the at least one detected adjacent node image.

10. The vision-based localization method of claim 1, further comprising,
determining the specific location based on the additional information; and
updating the map information based on the determining the specific location.

11. An apparatus for performing vision-based localization, the apparatus comprising:
at least one memory configured to store instructions; and
at least one processor configured to execute the instructions and cause the apparatus to,
transmit map information regarding a target space to a worker terminal,
receive, from the worker terminal, image information, the image information relating to an image captured at a specific location in the target space, and additional information, the additional information relating to the specific location, and
localize an image captured at the specific location, based on the image information and additional information received from the worker terminal.

12. A vision-based localization method performed by a worker terminal, the vision-based localization method comprising:
displaying map information regarding a target space on a display unit;
acquiring image information captured at a specific location in the target space;
receiving, from a worker input, additional information related to the specific location; and
localizing an image captured at the specific location based on the image information and the additional information.

13. The vision-based localization method of claim 12, wherein
the map information includes a plurality of node information; and
the additional information includes at least one adjacent node information of the plurality of node information, the at least one adjacent node information relating to at least one node adjacent to the specific location.

14. The vision-based localization method of claim 13, wherein the localizing includes
detecting at least one adjacent node image of at least one node adjacent to the specific location, and
local feature matching the image captured at the specific location with the at least one detected adjacent node image.

15. The vision-based localization method of claim 12, wherein the additional information includes camera location information relating to the specific location of the camera in the map information.

16. The vision-based localization method of claim 15, wherein, the localizing includes
detecting at least one adjacent node image captured at at least one node adjacent to the specific location based on the camera location information, and
local feature matching the image captured at the specific location with the at least one detected adjacent node image.

17. The vision-based localization method of claim 12, further comprising:
deleting at least one of the plurality of node information included in the map information in response to a node deletion command from the worker.
